(19) United States
(12) Patent Application Publication
(10) Pub. No.: US 2016/0266914 A1
(43) Pub. Date: Sep. 15, 2016

(54) Systems and Methods for Selecting Between Emulated and Non-Emulated Resources for Providing an Emulation Session

(71) Applicants: Giovanni Morelli, Mississauga (CA); Brandon Cowen, Mississauga (CA); Marian Dan, Mississauga (CA)

(72) Inventors: Giovanni Morelli, Mississauga (CA); Brandon Cowen, Mississauga (CA); Marian Dan, Mississauga (CA)

(21) Appl. No.: 15/065,251

(22) Filed: Mar. 9, 2016

Related U.S. Application Data
(60) Provisional application No. 62/130,865, filed on Mar. 10, 2015.

(51) Int. Cl. G06F 9/455

(52) U.S. Cl. CPC G06F 9/455

(57) ABSTRACT

Systems and methods for selecting between emulated and non-emulated hardware resources for providing an emulation session is disclosed. The method involves a plurality of emulation parameters including the computer product to be emulated, at least one kind of external hardware resource usable to provide the emulation, and selection criteria for determining whether to provide the at least one kind of external hardware resource as an emulated or a non-emulated hardware resource. The method includes receiving an emulation request from a client device; determining the plurality of emulation parameters; for each of the at least one kind of external hardware resource, selecting one and only one of the emulated and the non-emulated hardware resource to provide an operating instance of the at least one kind of external hardware resource based at least in part on the selection criteria; and providing the emulation to the client device using the selected resources.

### RELATED APPLICATIONS

This application claims priority from the U.S. patent application Ser. No. 62/130,865, filed Mar. 10, 2015 entitled “SYSTEMS AND METHODS FOR SELECTING BETWEEN EMULATED AND NON-EMULATED RESOURCES FOR PROVIDING AN EMULATION SESSION”, the disclosure of which is incorporated herein, in its entirety, by reference.

### FIELD

The described embodiments relate to systems and methods for selecting between emulated and non-emulated hardware resources for providing an emulation session.

### BACKGROUND

An emulator operates to imitate a computer product in an emulation session. The imitated computer product can be provided to a client device. The computer product can be a computer system, an operating environment, a software application, or one or more hardware and software components. The emulator system facilitates the emulation session by translating and processing instructions received from the client device into a format compatible with the emulated computer product.

The emulator server may be required to provide an operating instance of a kind of external hardware resource for the emulation session. Selecting between providing the kind of external hardware resource as an emulated hardware resource and a non-emulated hardware resource may improve operation of the emulator system.

### SUMMARY

The embodiments described herein provide in one aspect a system for initiating an emulation of a computer product. In some embodiments, the system can comprise a processor configured to receive an emulation request to provide the emulation at a client device. The emulation request can define the computer product and one or more properties of the emulation. The processor can be further configured to identify, based on the emulation request, a type of hardware resource required to provide the emulation. The processor can be further configured to determine, from a database, one or more criteria for selecting between providing the type of hardware resource as an emulated hardware resource and a non-emulated hardware resource. The processor can be further configured to select, based on the one or more criteria, between providing the type of hardware resource as an emulated hardware resource and a non-emulated hardware resource. The processor can be further configured to, in response to selecting providing the type of hardware resource as an emulated hardware resource, initiate the emulation using the non-emulated hardware resource; and in response to selecting providing the type of hardware resource for the emulation as a non-emulated hardware resource, initiate the emulation using the non-emulated hardware resource.

In accordance with an embodiment, there is provided a method of providing an emulation of a computer product, the method including receiving an emulation request for the computer product from a client device and determining, from the emulation request and the client device, a plurality of emulation parameters, including the computer product to be emulated, at least one kind of external resource usable to provide the emulation of the computer product, and selection criteria for determining whether to provide the at least one kind of external hardware resource as an emulated hardware resource or as a non-emulated hardware resource. The at least one kind of external resource includes at least one kind of external hardware resource usable to provide the emulation of the computer product. The at least one kind of external hardware resource is not providable by the client device and is providable as an emulated hardware resource and as a non-emulated hardware resource. The method can further include selecting selected resources for providing the emulation and providing the emulation to the client device using the selected resources. The selecting selected resources can include for each of the at least one kind of external hardware resource, selecting one and only one of the emulated hardware resource and the non-emulated hardware resource to provide an operating instance of the at least one kind of external hardware resource for the emulation based at least in part on the selection criteria.

In some embodiments, the selection criteria can include an emulated resource required state criteria that is satisfied if and only if an emulated resource state of at least one potential emulated hardware resource of that kind of external hardware resource is available, the emulated resource state being one of available and unavailable; and a non-emulated resource required state criteria that is satisfied if and only if a non-emulated resource state of at least one potential non-emulated hardware resource of that kind of external hardware resource is available, the non-emulated resource state being one of available and unavailable. The selecting selected resources can include selecting the one and only one of the emulated hardware resource and the non-emulated hardware resource based at least in part on the emulated resource required state criteria and the non-emulated resource required state criteria, the emulated hardware resource being selectable only if the emulated resource required state criteria is satisfied, and the non-emulated hardware resource being selectable only if the non-emulated resource required state criteria is satisfied.

In some embodiments, the method can further include determining the emulated resource state and the non-emulated resource state. The emulated resource state can be determined by determining an emulated resource operational characteristic defining usage of the at least one potential emulated resource of that kind of external hardware resource other than for the emulation; and determining that the emulated resource state is available when the emulated resource operational characteristic is less than a first threshold usage for the at least one potential emulated hardware resource of that kind of external hardware resource, and otherwise determining that the emulated resource state is unavailable. The non-emulated resource state can be determined by determining a non-emulated resource operational characteristic defining usage of the at least one potential non-emulated resource of that kind of external hardware resource other than for the emulation; and determining that the non-emulated resource state is available when the non-emulated resource operational characteristic is less than a second threshold usage for the at least one potential non-emulated hardware resource of that kind of external hardware resource, and otherwise determining that the non-emulated resource state is unavailable.

In some embodiments, the selecting selected resources can further include, for each of the at least one kind of external hardware resource, if one and only one of the non-emulated resource required state criteria and the emulated resource required state criteria is satisfied, selecting the one of the non-emulated hardware resource and the emulated hardware resource corresponding to the one of the non-emulated resource required state criteria and the emulated resource required state criteria that is satisfied, and if the non-emulated resource required state criteria and the emulated resource required state criteria are both satisfied, selecting the one of the non-emulated hardware resource and the emulated hardware resource based on at least one additional selection criterion of the selection criteria, otherwise, monitoring the emulated resource state and the non-emulated resource state until at least one of the emulated resource required state criteria and the non-emulated resource required state criteria is satisfied. Upon detecting that at least one of the emulated resource required state criteria and the non-emulated resource required state criteria is satisfied, the selecting selected resources can further include if one and only one of the non-emulated resource required state criteria and the emulated resource required state criteria is satisfied, selecting the one of the non-emulated hardware resource and the emulated hardware resource corresponding to the one of the non-emulated resource required state criteria and the emulated resource required state criteria that is satisfied, and otherwise, selecting the one of the non-emulated hardware resource and the emulated hardware resource based on at least one additional selection criterion of the selection criteria.

In some embodiments, for a particular kind of external hardware resource, an emulated hardware resource is initially selected to provide the operating instance for that particular kind of external hardware resource and the non-emulated resource required state criteria is initially not satisfied, the method can further include, for that particular kind of external hardware resource: monitoring the non-emulated resource state; detecting that the non-emulated resource required state criteria is satisfied from the monitoring of the non-emulated resource state; and upon detecting that the non-emulated resource required state criteria is satisfied, transitioning the operating instance for that particular kind of external hardware resource from being provided by the emulated hardware resource to being provided by the non-emulated hardware resource.

In some embodiments, for each of the at least one kind of external hardware resource, the at least one potential emulated hardware resource is providable by a first at least one emulator server amongst a plurality of emulator servers, and the emulated resource state is determined based on at least one emulator server specific emulated resource state, each emulator server specific emulated resource state being one of available and unavailable and corresponding to a state of a potential emulated hardware resource instance providable by a first particular emulator server of the first at least one emulator server, the emulated resource state being available if and only if any one of the at least one emulator server specific emulated resource state is available; and the at least one potential non-emulated hardware resource is providable by a second at least one emulator server amongst the plurality of emulator servers, and the non-emulated resource state is determined based on at least one emulator server specific non-emulated resource state, each emulator server specific non-emulated resource state being one of available and unavailable and corresponding to a state of a potential non-emulated hardware resource instance providable by a second particular emulator server of the second at least one emulator server, the non-emulated resource state being available if and only if any one of the at least one emulator server specific non-emulated resource state is available.

In some embodiments, the selecting the one and only one of the emulated hardware resource and the non-emulated hardware resource can include identifying selectable resource instances; selecting one of the selectable resource instances as a selected resource instance to provide the operating instance of that kind of external hardware resource; and selecting the one and only one of the emulated hardware resource and the non-emulated hardware resource based on the selected resource instance. The identifying selectable resource instances can include identifying each of the potential emulated hardware resource instances corresponding to an emulator server specific emulated resource state that is available as a selectable potential emulated resource instances; identifying each of the potential non-emulated hardware resource instances corresponding to an emulator server specific non-emulated resource state that is available as a selectable potential non-emulated resource instances; and identifying the selectable potential emulated resource instances and the selectable potential non-emulated resource instances as the selectable resource instances.

In some embodiments, the at least one additional selection criterion can include a relative performance criterion, and for each kind of external hardware resource, if the non-emulated resource required state criteria and the emulated resource required state criteria are both satisfied, the method can further include assessing the relative performance criterion and selecting the one of the non-emulated hardware resource and the emulated hardware resource based on the relative performance criterion. The assessing the relative performance criterion can include determining an emulated resource performance indicator defining performance of at least one potential emulated hardware resource of that kind of external hardware resource; determining a non-emulated resource performance indicator defining performance of at least one potential non-emulated hardware resource of that kind of external hardware resource; and assessing the relative performance criterion by comparing the emulated resource performance indicator and the non-emulated resource performance indicator, the relative performance criterion indicating one of greater emulated resource performance, greater non-emulated resource performance, and substantially equal resource performance.

In some embodiments, for a particular kind of external hardware resource, the relative performance criterion initially indicates one of greater emulated resource performance and greater non-emulated resource performance, and a particular one of the emulated hardware resource and the non-emulated hardware resource is initially selected corresponding to the one of the greater emulated resource performance and the greater non-emulated resource performance to provide the operating instance for that particular kind of external hardware resource, and the method can further include for that particular kind of external hardware resource monitoring the non-emulated performance indicator and the emulated performance indicator; and detecting a change in the relative performance criterion to indicate a new relative performance criterion state from the monitoring of the non-emulated performance indicator and the emulated performance indicator. Upon detecting the change in the relative performance criterion, if the new relative performance criterion state indicates greater emulated resource performance, the method can include transitioning the operating instance of that kind of external hardware resource to the emulated hardware resource. Upon detecting the change, if the new relative performance criterion state indicates greater non-emulated resource performance, the method can include transitioning the operating instance of that kind of external hardware resource to the non-emulated hardware resource. Otherwise, upon detecting the change in the relative performance criterion, determining if the operating instance of that kind of external hardware resource should be maintained on the particular one of the emulated hardware resource and the non-emulated hardware resource initially selected based on another at least one additional selection criterion. If the operating instance of that kind of external hardware resource should not be maintained, then the method can include transitioning the operating instance of that kind of external hardware resource to the other of the emulated hardware resource and the non-emulated hardware resource; otherwise the method can include maintaining the operating instance on the particular one of the emulated hardware resource and the non-emulated hardware resource initially selected.

In some embodiments, the relative performance criterion can include a static performance criterion and the selecting the one and only one of the emulated hardware resource and the non-emulated hardware resource is based on the static performance criterion. The static performance criterion can be assessed by determining an emulated resource static performance indicator defining an emulated static performance of at least one potential emulated hardware resource of that kind of external hardware resource, the emulated resource static performance indicator determined based at least in part on defined emulated performance specifications of the at least one potential emulated resource of that kind of external hardware resource; determining a non-emulated resource static performance indicator defining a non-emulated static performance of at least one potential emulated hardware resource of that kind of external hardware resource, the non-emulated resource static performance indicator determined based at least in part on defined non-emulated performance specifications of the at least one potential non-emulated resource of that kind of external hardware resource; and assessing the static performance criterion by comparing the emulated resource static performance indicator and the non-emulated resource static performance indicator.

In some embodiments, the static performance criterion indicates greater emulated static resource performance if the emulated static performance indicator is greater than the non-emulated static performance indicator by an emulated static performance threshold; indicates greater non-emulated static resource performance if the non-emulated resource static performance indicator is greater than the emulated static performance indicator by a non-emulated static performance threshold; and otherwise indicates substantially equal static resource performance. In some embodiments, the selecting the one and only one of the emulated hardware resource and the non-emulated hardware resource based on the static performance criterion can include: if the static performance criterion indicates the greater emulated static resource performance, then selecting the emulated hardware resource; if the static performance criterion indicates the greater non-emulated static resource performance, then selecting the non-emulated hardware resource; and if the static performance criterion indicates substantially equal static resource performance, then selecting the one and only one of the emulated hardware resource and the non-emulated hardware resource based on another at least one additional selection criterion.

In some embodiments, the relative performance criterion can include a dynamic performance criterion and the selecting the one and only one of the emulated hardware resource and the non-emulated hardware resource is based on the dynamic performance criterion. The dynamic performance criterion can be assessed by determining an emulated resource dynamic performance indicator defining an emulated dynamic performance of at least one potential emulated hardware resource of that kind of external hardware resource, the emulated resource dynamic performance indicator determined based at least in part on an emulated resource operational characteristic and performance specifications of the at least one potential emulated resource, the emulated resource operational characteristic defining usage of the at least one potential emulated resource of that kind of external hardware resource other than for the emulation; determining a non-emulated resource dynamic performance indicator defining a non-emulated dynamic performance of at least one potential emulated hardware resource of that kind of external hardware resource, the non-emulated resource dynamic performance indicator determined based at least in part on determining a non-emulated resource operational characteristic and performance specifications of the at least one potential non-emulated resource, the non-emulated resource operational characteristic defining usage of the at least one potential non-emulated resource of that kind of external hardware resource other than for the emulation; and assessing the dynamic performance criterion by comparing the emulated resource dynamic performance indicator and the non-emulated resource dynamic performance indicator.

In some embodiments, the dynamic performance criterion indicates greater emulated dynamic resource performance if the emulated dynamic performance indicator is greater than the non-emulated dynamic performance indicator by an emulated dynamic performance threshold; indicates greater non-emulated dynamic resource performance if the non-emulated resource dynamic performance indicator is greater than the emulated dynamic performance indicator by a non-emulated dynamic performance threshold; and otherwise indicates substantially equal dynamic resource performance. In some embodiments, the selecting the one and only one of the emulated hardware resource and the non-emulated hardware resource based on the dynamic performance criterion can include: if the dynamic performance criterion indicates the greater emulated dynamic resource performance, then selecting the emulated hardware resource; if the dynamic performance criterion indicates the greater non-emulated dynamic resource performance, then selecting the non-emulated hardware resource; and if the dynamic performance criterion indicates substantially equal dynamic resource performance, then selecting the one and only one of the emulated hardware resource and the non-emulated hardware resource based on another at least one additional selection criterion.

In some embodiments, the at least one additional selection criterion can include a default selection of one of the non-emulated hardware resource and the emulated hardware resource.

In some embodiments, the plurality of emulation parameters can further include a first user priority corresponding to a user of the client device, the first user priority being one of a plurality of ordered priorities. In some embodiments, the method can further include determining that a particular one of the emulated resource required state criteria and the non-emulated resource required state criteria is not satisfied; identifying usage of one of the at least one potential non-emulated hardware resource and the at least one potential emulated hardware resource to provide, at a second client device, a second operating instance of the at least one kind of external hardware resource for a second emulation at the second client device, the one of the at least one potential non-emulated hardware resource and the at least one potential emulated hardware resource corresponding to the particular one of the emulated resource required state criteria and the non-emulated resource required state criteria that is not satisfied; determining a second user priority for a user of the second client device; determining that the second user priority is lower in priority than the first user priority; stopping provision of the second operating instance by the one of the at least one potential non-emulated hardware resource and the at least one potential emulated hardware resource; and selecting the one of the at least one potential non-emulated hardware resource and the at least one potential emulated hardware resource to provide the operating instance of the at least one kind of external hardware resource for the emulation.

### DETAILED DESCRIPTION OF DRAWINGS

Several embodiments of the present invention will now be described in detail with reference to the drawings, in which:

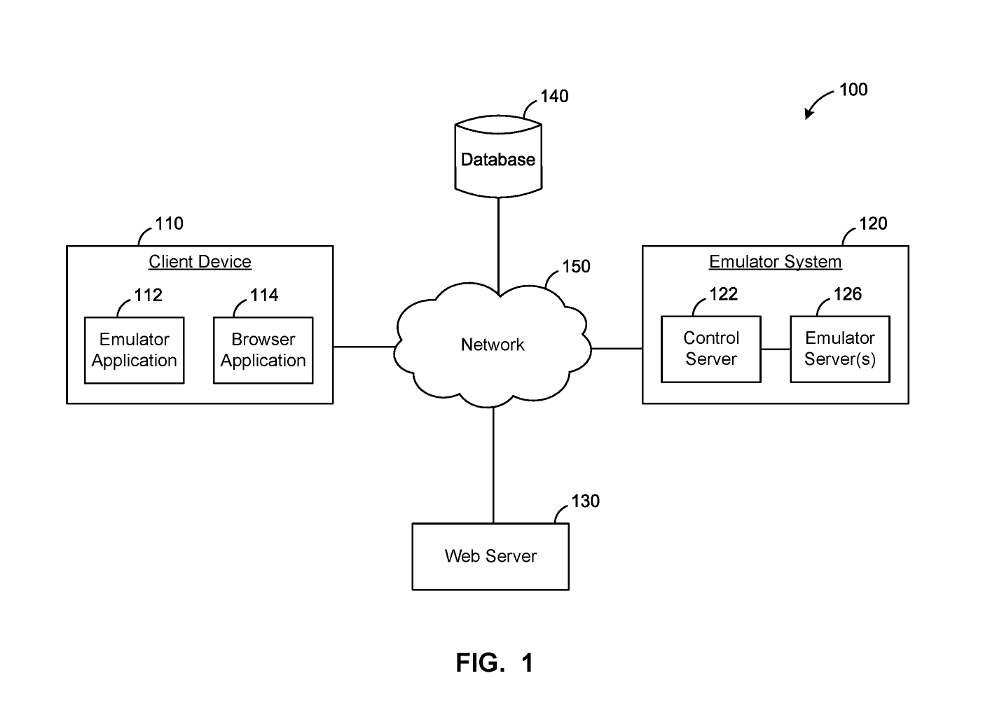

FIG. 1 is a block diagram illustrating an emulator system in communication with other components, in accordance with an example embodiment;

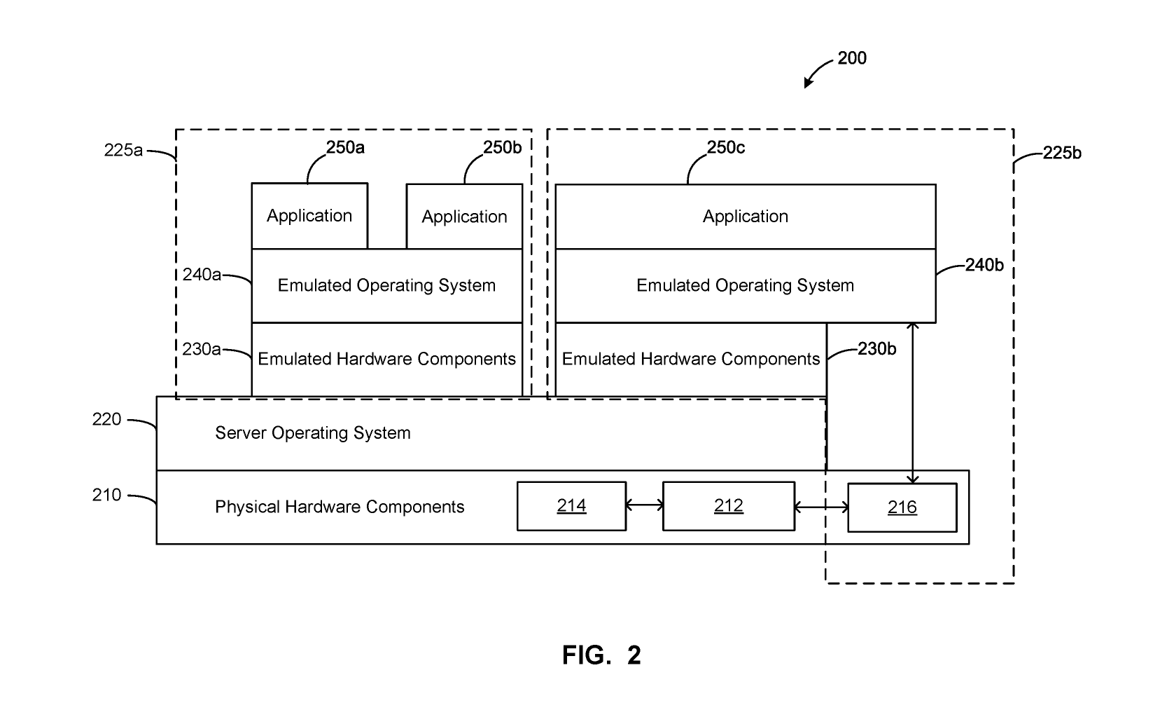

FIG. 2 is a simplified computer architecture diagram of an emulator server, in accordance with an example embodiment;

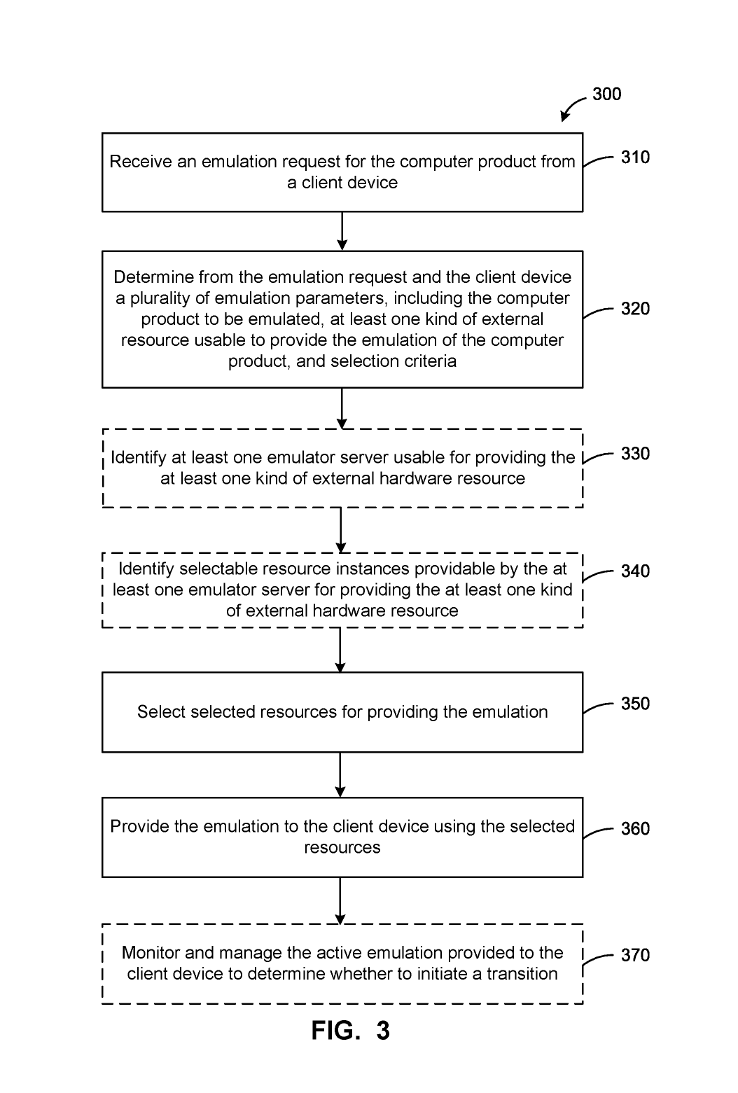

FIG. 3 is a flowchart illustrating a process for providing the emulation, in accordance with an example embodiment; and

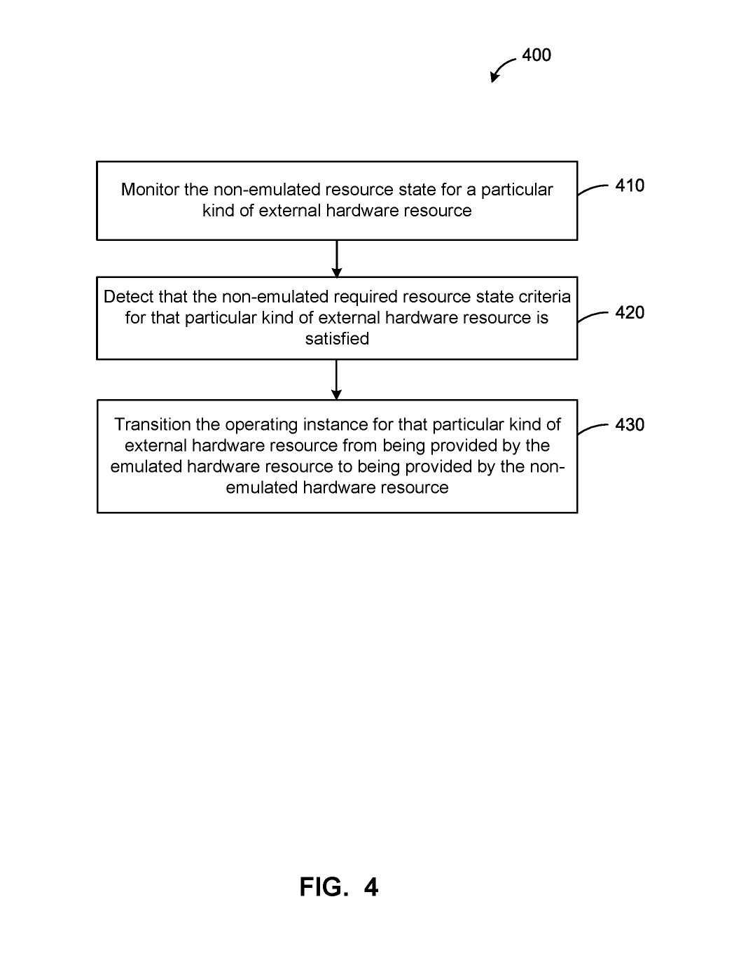

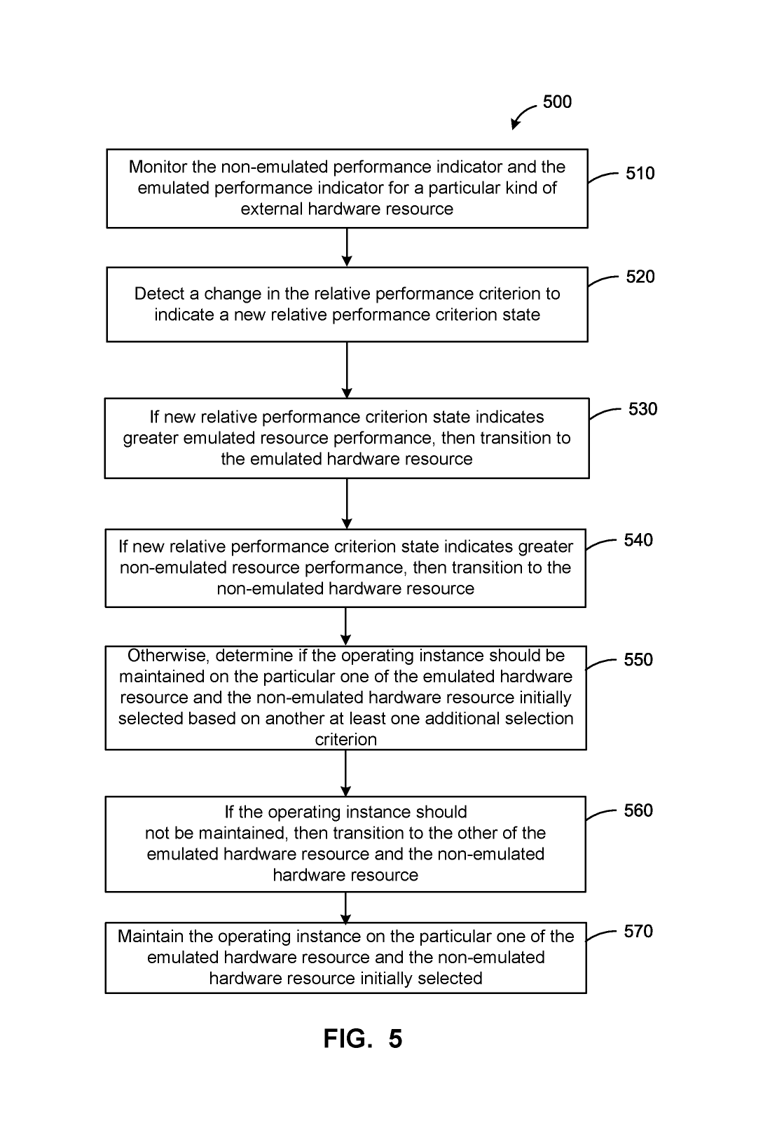

FIGS. 4 and 5 are flowcharts illustrating processes for transitioning between emulated and non-emulated hardware resources in accordance with some example embodiments.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. It will be appreciated that for simplicity and clarity of illustration, where considered appropriate, reference numerals may be repeated among the figures to indicate corresponding or analogous elements or steps.

### DETAILED DESCRIPTION OF EXEMPLARY EMBODIMENTS

The embodiments of the systems, processes, and methods described herein may be implemented in hardware or software, or a combination of both. Alternatively, these embodiments may also be implemented in computer programs executed on programmable computers each comprising at least one processor (e.g., a microprocessor), a data storage system (including volatile and non-volatile memory or storage elements), at least one input device, and at least one output device. For example and without limitation, the programmable computers (referred to below as computing devices) may be a personal computer, laptop, personal data assistant, cellular telephone, smart-phone device, tablet computer, or wireless device. For any software components, program code is applied to input data to perform the functions described herein and generate output information. The output information is applied to one or more output devices, in known fashion.

Each software component or program may be implemented in a high level procedural or object oriented programming or scripting language to communicate with a computer system. However, the programs can be implemented in assembly or machine language, if desired. In any case, the language may be a compiled or interpreted language. Each such computer program is preferably stored on a storage media or a device (e.g., ROM (read-only memory)) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

The various embodiments described herein generally relate to a system and related methods for selecting between emulated and non-emulated hardware resources for providing an emulation of a computer product.

### FIG. 1

Reference is first made to FIG. 1, which illustrates a block diagram 100 of an emulator system 120 in communication with other components in accordance with an example embodiment.

As shown in FIG. 1, emulator system 120 may communicate with a client device 110, a web server 130, and a database 140 over a network 150. Similarly, each of client device 110, web server 130, and database 140 may also communicate with each other over network 150. The network 150 may include, for example, a mobile network, the internet, or a virtual emulator network.

### Client Device 110

Client device 110 may generally be any computing device capable of network communication. It will be understood that, for ease of exposition, only one client device 110 is illustrated, but two or more client devices may be used. Client device 110 can include a processing component and a memory component. For example client device 110 may be a personal computer, laptop, personal data assistant, cellular telephone, smart-phone device, tablet computer, wireless device, etc.

Client device 110 may include one or more software and hardware modules. For example, as illustrated in FIG. 1, the software modules may include an emulator application 112 and a browser application 114. Emulator application 112 can enable compatibility between client device 110 and emulator system 120. For example, the emulator application 112 may enable client device 110 to properly interface with any software and hardware components that may be provided at emulator system 120. Browser application 114 may be executed on client device 110 for providing a browser with which a user may access the network 150.

The hardware modules provided on client device 110 may include any known hardware components for operating client device 110. For example, the hardware modules may include an interface module for receiving and transmitting data (e.g., a USB (universal serial bus) port, one or more peripheral ports, etc.), a processor module (e.g., a CPU (central processing unit)), a storage module (e.g., RAM (random access memory)), a navigation module (e.g., a GPS (global positioning system)), a multimedia module (e.g., a sound card, a video card, etc.), a communication module for providing communication with external components or devices (e.g., via radio-frequency, wireless, Bluetooth™ communication, etc.), one or more user interface components (e.g., a touch screen, a keyboard, a display, etc.), or other modules for providing additional features (e.g., a gyroscope, etc.).

It will be understood that other software or hardware components may be provided on client device 110.

### Database 140

Database 140 is provided to store and provide various data information associated with any of client device 110, web server 130, and emulator system 120. For example, database 140 can store information associated with certain computer products to be emulated, such as data defining the kinds of software and hardware resources usable for emulating each of the computer products. Database 140 can also store data defining software and hardware resources and operational characteristics of emulator system 120. Database 140 may be accessible over the network 150 by any of client device 110, web server 130, and emulator system 120.

It will be appreciated that in some embodiments, database 140 may be provided as part of emulator system 120. It will further be appreciated that other databases may be provided in addition to, or in lieu of, database 140. For example, in some embodiments, control server 122 may include a control server database that can provide the same or similar functionality as database 140.

### Web Server 130

Web server 130 can generally be used to host a website or one or more webpages that act as a portal to emulator system 120. It will be appreciated that in some embodiments, web server 130 may be provided as part of emulator system 120. For example, control server 122 may include web server 130, and therefore, also host the website.

The website may include a user interface for receiving a user request for initiating an emulation session at emulator system 120. For example, client device 110 may display the website using browser application 114, and web server 130 providing the displayed website may receive data from client device 110 via the website. Web server 130 may forward the received data to emulator system 120 for initiating a corresponding emulation session.

User requests for initiating an emulation session may be referred to as emulation requests. In response to receiving an emulation request, emulator system 120 may implement the emulation request.

### Emulator System 120

Emulator system 120 may include one or more components for providing an emulation of a computer product based on the emulation request received from client device 110. The components may include an emulation control server 122 and one or more emulator servers 126.

Although emulator system 120 may include multiple emulator servers 126, in some embodiments, emulator system 120 may include a single emulator server 126. Further, although control server 122 and emulator servers 126 are shown as separate computer servers, it will be understood that in some embodiments, control server 122 and one or more emulator servers 126 may be provided as one computer server. It will be further understood that any one of control server 122 and each emulator server 126 may be provided as two or more computer servers.

Control server 122 and each emulator server 126 can include a processing component and a memory component. For example, control server 122 may include a control processor and each emulator server 126 may include a respective emulator processor. It will be understood that in some embodiments, the control processor and an emulator processor may be provided as the same processor. In other embodiments, the control processor or an emulator processor may be provided as two or more processors.

Control server 122 can generally operate to create one or more emulation sessions in response to receiving an emulation request, and track and manage each created session based on a session identifier.

Each emulator server 126 can generally operate to provide an emulation of a computer product based on the emulation request received from client device 110. To do so, emulator server 126 may provide or make available one or more operating instances of each kind of hardware and software resources usable for providing each emulation session. In respect of hardware resources, emulator server 126 may be operable to provide a kind of external hardware resource as both an emulated hardware resource and a non-emulated hardware resource.

In the description that follows, an operating instance of an emulated hardware resource providable by an emulator server may be referred to as an emulated hardware resource providable by the emulator server; however, it is understood that the emulator server provides an operating instance of the emulated hardware resource. Likewise, an operating instance of a non-emulated hardware resource providable by an emulator server may be referred to as a non-emulated hardware resource providable by the emulator server; however, it is understood that the emulator server provides an operating instance of the non-emulated hardware resource.

### FIG. 2

For example, reference is made to FIG. 2, which illustrates an example hardware and software layering architecture 200 of an emulator server 126 used for providing emulation sessions 225a and 225b.

Emulated hardware resources can be one or more emulated hardware components 230 operating above the level of server operating system 220. Emulated hardware components 230 can be software-based constructs operable to reproduce the function of hardware components usable for emulating a requested computer product. For example, the requested computer product of emulation session 225a may be an operating system 240a designed to execute on hardware components 230a, or one or more applications 250a, 250b designed to execute on operating system 240a. The emulated hardware components 230a may therefore form an emulated hardware architecture used for executing operating system 240a and applications 250a, 250b.

Non-emulated hardware resources can be one or more physical hardware components 210 of emulator server 126. Physical hardware components 210 form the physical hardware architecture of emulator server 126, and operate below the level of operating system 220. For example, physical hardware components 210 can include the main server processor 212 used to execute operating system 220, and can also include other hardware components 214, 216, such as memory, auxiliary processors, graphical processing units (GPUs), etc. Hardware components 214, 216 may be operable to communicate with the main server processor 212 via the internal server bus of emulator server 126. The internal server bus is the communication system that transfers data between physical hardware components 210 inside emulator server 126.

In some embodiments, the physical hardware components 210 of the emulator server 126 may include one or more hardware components usable for providing an emulation of a requested application 250c. For example, the requested application 250c may be the application Angry Birds™ for the Android™ platform. In this case, the kinds of hardware resources usable to provide emulated operating system 240b and application 250c may include at least an ARM™ (Advanced RISC Machine) processor. An ARM processor is a microprocessor based on the RISC (reduced instruction set computer) computer instruction set developed by ARM Holdings Public Limited Company. An ARM processor can be used to execute the Android operating system.

In some embodiments, hardware component 216 may be a physical ARM processor operable to communicate with the main server processor 212 below the level of operating system 220 via the internal server bus of emulator server 126. For example, the physical ARM processor may be operable to communicate with the main server processor via a PCI (peripheral component interconnect) bus. As shown in FIG. 2, the physical ARM processor 216 may be used to provide emulated operating system 240b and application 250c. The remaining kinds of hardware resources usable to provide operating system 240b and application 250c may be provided as emulated hardware components 230b.

As will be described in more detail below with respect to FIG. 3, in some embodiments, emulator system 120 may operate to select between providing a kind of external hardware resource as an emulated and non-emulated hardware resource.

Continuing with the above Angry Birds example, in addition to being operable to provide the ARM processor by using the physical ARM processor 216, emulator server 126 may also be operable to provide the ARM processor through emulation (i.e., as one of the emulated hardware components 230b). In some embodiments, emulator system 120 may determine that it is more advantageous to use the physical ARM processor 216 for emulation session 225b due to, for example, the communication between the physical ARM processor 216 and the main server processor 212 occurring below the level of the server operating system 220. Communicating below the level of operating system 220 may result in faster communication than would occur between the main processor and an emulated hardware component 230b operating above the level of server operating system 220. Alternatively, if the physical ARM processor 216 is operating at capacity, or is otherwise unavailable, emulator system 120 may select to provide the ARM processor as an emulated hardware component 230b.

### FIG. 3

Reference is now made to FIG. 3, which is a flowchart illustrating an example process 300 for providing client device 110 with an emulation of a requested computer product in accordance with an example embodiment.

### Step 310

At step 310, control server 122 receives an emulation request from client device 110. The emulation request may include user data for identifying and authenticating the user requesting the emulation. The emulation request may also include client device data for identifying and authenticating client device 110. The emulation request can further include emulation data indicating aspects of the emulation being requested by the user. The emulation data may define at least one of a computer product to be emulated and one or more properties of the emulation. The emulation request may include metadata, from which the user data, client device data, and emulation data may be determinable.

In response to receiving the emulation request, control server 122 can operate to create an emulation session for that emulation request. Control server 122 may create the emulation session based on the emulation data corresponding to the emulation request.

When the emulation session is created, control server 122 may also create an emulation session identifier for that emulation session. Control server 122 can associate the emulation session identifier with that emulation session. The emulation session identifier may be unique to the emulation session being provided for client device 110. The emulation session identifier may be stored in database 140.

### Step 320

At step 320, control server 122 can determine a plurality of emulation parameters from the emulation request and the client device 110. The plurality of emulation parameters can include the emulation being requested by the user, at least one kind of external resource usable for providing the requested emulation, and selection criteria.

The at least one kind of external resource usable for providing the requested emulation can include one or more hardware and software resources not providable by the client device 110. The at least one kind of external hardware resource can be provided as an emulated hardware resource and as a non-emulated hardware resource. The selection criteria can be used to determine whether to provide the at least one kind of external hardware resource as an emulated hardware resource or as a non-emulated hardware resource. In some embodiments, database 140 may include data defining the at least one kind of external hardware resource usable for implementing different emulations. Control server 122 may therefore determine from database 140 the at least one kind of external hardware resource usable for providing the requested emulation.

Control server 122 can then operate to link the at least one kind of external hardware resource with the emulation session identifier. For example, control server 122 may link an identifier for each of the at least one kind of external hardware resource with the emulation session identifier by storing the external hardware resource identifiers in association with the emulation session identifier in database 140.

### Step 330

In some embodiments, the emulator system 120 may include multiple emulator servers 126 and at step 330, control server 122 can identify at least one emulator server 126 from amongst the multiple emulator servers 126 for providing the at least one kind of external hardware resource. In some embodiments, control server 322 may identify at least one emulator server 126 based on a predefined order that may be provided in database 140. In another example, control server 122 may identify at least one emulator server 126 based on a variety of factors or emulator server characteristics, such as capability of providing the kind of external hardware resource; capability of providing the kind of external hardware resource as emulated or non-emulated hardware resources; operational characteristics of the emulator server or its resources, such as computational performance, computational efficiency, availability, status, operational load, etc.; user data; client device data; and other similar factors.

After identifying at least one emulator server 126, control server 122 may link identifiers corresponding to the at least one identified emulator server 126 with the emulation session identifier. For example, control server 122 may operate to store the emulator server identifier in database 140 in association with the emulation session identifier. In some embodiments, control server 122 may identify more than one emulator server 126 for providing the at least one kind of external hardware resource. In this case, control server 122 may link emulator server identifiers for each of the at least one identified emulator server 126 with the emulation session identifier. If emulator system 120 includes only one emulator server 126, then step 330 may be omitted, as shown by dashed lines in FIG. 3.

### Step 340

If emulator system 120 includes a plurality of emulator servers, at step 340, control server 122 can identify, for each of the at least one kind of external hardware resource, at least one potential emulated hardware resource and at least one potential non-emulated hardware resource that the at least one identified emulator server 126 is capable of providing an operating instance of. That is, operating instances for each of the at least one potential emulated hardware resource and at least one potential non-emulated hardware resource may be specific to one of the at least one identified emulator server 126. In some embodiments, control server 122 may request each of the at least one emulator server 126 to provide data identifying the at least one potential emulated hardware resource and the at least one potential non-emulated resource for each of the at least one kind of external hardware resource that emulator server 126 is capable of providing an operating instance of.

In some embodiments, database 140 may include data defining the kinds of hardware and software resources that each of the at least one identified emulator server 126 is capable of providing an operating instance of. Database 140 may further include data defining which kinds of these external hardware resources the at least one identified emulator server 126 is capable of providing both through emulation and by using a physical hardware component, or non-emulation, that is one of the at least one kind of external hardware resource usable for providing the emulation.

Control server 122 may therefore determine from data received from the at least one identified emulator server 126 or retrieved from database 140 which of the at least one kind of external hardware resource the at least one identified emulator server 126 is capable of providing as both an emulated hardware resource and a non-emulated hardware resource. Control server 122 may then link this data with the emulation session identifier and respective identifiers for the at least one kind of external hardware resource in database 140.

### Step 350

At step 350, for each of the at least one kind of external hardware resource that the at least one identified emulator server 126 is capable of providing as both an emulated hardware resource and a non-emulated hardware resource, control server 122 can select whether the at least one identified emulator server 126 provides that kind of external hardware resource as an emulated or non-emulated hardware resource.

Control server 122 can operate to make this selection based on one or more selection criteria stored in database 140, or by considering and balancing various operational characteristics associated with the identified emulator server 126 or emulator system 120. Control server 122 may also consider the operational characteristics in view of selection criteria. Selection criteria may include, for example, required state criteria for each of the emulated and non-emulated hardware resource, a relative performance criterion, a default selection, an operational load threshold, and other similar criteria. Operational characteristics of each of the at least one identified emulator server 126 may include resource capabilities, parameters, status, availability, capacity, operational load, computational efficiency, computational performance, and other similar factors.

It will be understood that control server 122 may retrieve selection criteria from database 140. It will further be understood that control server 122 may track the operational characteristics of each of the at least one identified emulator server 126 by, for example, receiving and processing operational data from the identified emulator server 126. Alternatively, or in addition, the operational data may be stored in and retrieved from database 140.

### Resource Selection Protocol

In some embodiments, control server 122 may retrieve a resource selection protocol from database 140. The resource selection protocol may specify the selection criteria and operational characteristics to consider and the procedure to follow for selecting between emulated and non-emulated hardware resources.

In some embodiments, the resource selection protocol may provide instructions for control server 122 to select, for each kind of external hardware resource usable for providing the emulation, between providing potential emulated hardware resources and potential non-emulated hardware resources based on operational characteristics such as a state condition, or a resource state, of each of the potential emulated hardware resources and potential non-emulated hardware resources. A resource state can indicate the availability of a respective potential hardware resource for the current emulation. The resource state may be one of an available state, an error state, and an unavailable state. Furthermore, in the case where each of the potential emulated and non-emulated hardware resources are providable by more than one of the at least one identified emulator server 126, the resource state for that potential emulated and non-emulated hardware resource can be a server specific resource state. The selection criteria may include a resource required state criteria indicating a required status, or a required resource state, or a required state condition, for the potential emulated hardware resource and the potential non-emulated hardware resource. The required state condition may be, for example, an available state. A potential emulated hardware resource may only be selectable if the emulated resource state criterion is satisfied and a potential non-emulated hardware resource may only be selectable if the non-emulated resource state criterion is satisfied. For example, if the required state condition is an available state, the potential emulated hardware resource may only be selectable if the resource state of that potential emulated hardware resource is available.

In some embodiments, the resource state may be determined based on whether a respective potential hardware resource of that kind of external hardware resource is operating at or close to its operational capacity. For example, the selection criteria may include operational load thresholds indicating a maximum usage for each of the potential emulated and non-emulated hardware resources. The operational characteristics for each of the at least one identified emulator server 126 may include an emulated resource current load amount and a non-emulated resource current load amount. The current load amount for a potential hardware resource can indicate its existing usage other than for providing the emulation requested. The maximum usage and the existing usage may be defined based on the kind of external hardware resource.

For example, the kind of external hardware resource usable may be a MIPS™ (Microprocessor without Interlocked Pipeline Stages) processor. A MIPS processor is a microprocessor based on the RISC (reduced instruction set computer) computer instruction set developed by MIPS Technologies, Inc.

In this case, the potential non-emulated hardware resource may be a physical MIPS processor capable of communicating with the main processor of one of the identified emulator server 126 via the internal server bus. The existing usage for the potential non-emulated hardware resource may be defined based on the percentage of processing power currently being used by the MIPS processor to, for example, provide other emulation sessions. The maximum usage may be defined based on a threshold percentage of processing power beyond which the MIPS processor would be unable to effectively provide the requested emulation, or one of the other emulation sessions, if used as that kind of external hardware resource.

Continuing with the above example, the potential emulated hardware resource may be a software construct operable to emulate the functionality of a MIPS processor by executing on the main processor of one of the identified emulator server 126. In this case, the existing usage for the potential emulated hardware resource may be defined based on the percentage of processing power currently being used by the main processor to, for example, provide other emulation sessions. The maximum usage may be defined based on a threshold percentage of processing power beyond which the main processor would be unable to effectively provide the requested emulation, or one of the other emulation sessions, if used to execute the software construct for emulating the functionality of the MIPS processor.

To determine the resource state, control server 122 can compare the current load amount of a respective potential hardware resource with its operational load threshold. If the current load amount is less than the operational load threshold, then control server 122 can associate the resource state of that potential hardware resource with an available state. If the current load amount is equal to or greater than the operational load threshold, then control server 122 can associate the resource state of that potential hardware resource with an unavailable state. If the potential hardware resource is experiencing an operational error, then control server 122 can associate the resource state of that potential hardware resource with an error state.

After determining the resource state for the potential emulated hardware resource and the potential non-emulated hardware resource, control server 122 can compare each resource state with the required resource state of the resource required state criteria. If a resource state corresponds to the required resource state, then control server 122 can indicate that the corresponding potential hardware resource satisfies the resource required state criteria. If a resource state fails to correspond to the required resource state, then control server 122 can indicate that the corresponding potential hardware resource fails to satisfy the resource required state criteria.

Control server 122 may then select between the potential emulated and non-emulated hardware resource for each the at least one kind of external hardware resource based on the resource required state criteria. In some embodiments, control server 122 can only select the emulated hardware resource if the emulated resource required state criteria is satisfied and the control server 122 can only select the non-emulated hardware resource if the non-emulated resource required state criteria is satisfied.

### Only One Type of Resource Satisfies the Required State Criteria

For example, if for a kind of external hardware resource, the emulated resource required state criteria is satisfied and the non-emulated resource required state criteria is not satisfied, then control server 122 may select the potential non-emulated hardware resource to provide that kind of external hardware resource. In some embodiments, before selecting the potential non-emulated hardware resource in such a scenario, control server 122 may determine whether another emulator server 126 is capable of providing that kind of external hardware resource as an emulated hardware resource. If so, control server 122 may restart the resource selection protocol for that kind of external hardware resource to select between the potential non-emulated hardware resource of the at least one identified emulator server 126 and the potential emulated hardware resource of the other emulator server 126.

Similarly, if for a kind of external hardware resource the emulated resource required state criteria is satisfied and the non-emulated resource required state criteria is not satisfied, then control server 122 may select the potential emulated hardware resource. In some embodiments, before selecting the potential emulated hardware resource in such a scenario, control server 122 may determine whether another emulator server 126 is capable of providing that kind of external hardware resource as a non-emulated hardware resource. If so, control server 122 may restart the resource selection protocol for that kind of external hardware resource to select between the potential emulated hardware resource of the at least one identified emulator server 126 and the potential non-emulated hardware resource of the other emulator server 126.

### Both Types of Resources Satisfy the Required State Criteria

If for a kind of external hardware resource both the emulated resource required state criteria and the non-emulated resource required state criteria are satisfied, then in some embodiments, the resource selection protocol may specify that the control server 122 select between the potential emulated and non-emulated hardware resource for each the at least one kind of external hardware resource based on an additional selection criterion. In some embodiments, the additional selection criteria may include a default selection for that kind of external hardware resource. For example, the resource selection protocol may specify that the potential non-emulated hardware resource should be selected by default in cases where both the emulated resource required state criteria and the non-emulated resource required state criteria are satisfied. It will be understood that in some embodiments, specifying the potential non-emulated hardware resource as the default selection may be preferred. As outlined above, non-emulated hardware resources may be operable to communicate with the main processor directly via the internal server bus. As a result, non-emulated hardware resources can generally provide improved performance compared to emulated hardware resources.

In some embodiments, the resource selection protocol may specify a relative performance criterion as the additional selection criterion. In this case, control server 122 may select between potential emulated and non-emulated hardware resources for a kind of external hardware resource based on a performance benchmark, or performance indicators, indicating the relative performance of each potential hardware resource for that kind of external hardware resource. The performance indicators may be determined based on one or more performance metrics. Performance metrics can include, for example, response time, processing speed, operational capacity, efficiency, reliability, etc. The current operational characteristics of a resource and each of the at least one identified emulator server 126 may also be considered in determining the performance indicator.

In some embodiments, the performance indicator may be a static performance indicator. A static performance indicator for a potential hardware resource may indicate the relative performance of that potential hardware resource for a kind of external hardware resource based on performance metrics of its defined performance specifications, without considering current operational characteristics of the potential hardware resource or the at least one identified emulator server 126. For example, a static performance indicator may be based on the minimum, average, or maximum response time of a potential hardware resource, or the maximum effective processing speed of a potential hardware resource, for a kind of external hardware resource. Control server 122 may retrieve the static performance indicator for the potential emulated and non-emulated hardware resource from database 140.

In some embodiments, the performance indicator may be a dynamic performance indicator. A dynamic performance indicator for a potential hardware resource may indicate a relative predicted performance of a requested emulation session if that potential hardware resource is selected for a kind of external hardware resource usable for providing the emulation. The dynamic performance indicator may be determined based on the performance metrics of its defined performance specifications outlined above, and taking into account the requested emulation and the current operational characteristics of the potential hardware resource and the at least one identified emulator server 126.

For example, to determine the dynamic performance indicator for the potential non-emulated hardware resource, control server 122 may request operational data from each of the at least one identified emulator server 126. The operational data may define the operational state and characteristics of each of the at least one identified emulator server 126, including the operational state and characteristics of its resources. For example, the operational data may define the current status and operational load of each physical hardware component of emulator server 126 usable for providing a kind of external hardware resource for providing the requested emulation.

Based on the operational data and the computer product to be emulated, control server 122 may predict the expected performance characteristics of the requested emulation if the potential non-emulated hardware resource is selected for the emulation. Control server 122 may then determine the dynamic performance indicator based on the expected performance characteristics in view of one or more performance metrics. A similar method may be followed to determine the dynamic performance indicator for the potential emulated hardware resource.

After determining or retrieving one or more performance indicators for both the potential emulated and non-emulated hardware resource for a kind of external hardware resource, control server 122 can assess the relative performance criterion for that kind of external hardware resource by comparing respective performance indicators. That is, the control server 122 can assess a static performance criterion for a kind of external hardware resource by comparing the static performance indicator of the potential emulated hardware resource and the static performance indicator of the potential non-emulated hardware resource. As well, the control server 122 can assess a dynamic performance criterion for a kind of external hardware resource by comparing the dynamic performance indicator of the potential emulated hardware resource and the dynamic performance indicator of the potential non-emulated hardware resource. The static relative performance criterion, or the dynamic performance criterion, for a kind of external hardware resource can indicate one of greater emulated resource performance, greater non-emulated resource performance, and substantially equal resource performance.

In some embodiments, control server 122 can then select between the emulated and non-emulated hardware resource for a kind of external hardware resource based on the relative performance criterion for that kind of external hardware resource. In some embodiments, control server 122 can select the emulated hardware resource if the relative performance criteria indicate greater emulated resource performance and the control server 122 can only select the non-emulated hardware resource if the relative performance criteria indicate greater non-emulated resource performance. In some embodiments, if the relative performance criteria indicate substantially equal resource performance, the resource selection protocol can specify additional selection criteria such as the default selection described above.

### Neither Type of Resource Satisfies the Required State Criteria

If for a kind of external hardware resource neither the emulated resource required state criteria nor the non-emulated resource required state criteria are satisfied, control server 122 may return an error message indicating that that kind of external hardware resources are unavailable at this time. Control server 122 may then monitor by periodically checking for a change in the resource state of each potential hardware resource. If a change is detected in either the potential emulated or non-emulated hardware resource state, then control server 122 may determine whether the new emulated resource required state criteria or the new non-emulated resource required state criteria are satisfied. If so, control server 122 may select that potential hardware resource for providing that kind of external hardware resource required for the emulation. If a change is detected in both the potential emulated and non-emulated hardware resource state, then in some embodiments, the resource selection protocol may specify that the control server 122 select between the potential emulated and non-emulated hardware resource for each the at least one kind of external hardware resource based on an additional selection criterion. In some embodiments, the additional selection criteria may specify a default selection for that kind of external hardware resource. In some embodiments, the additional selection criteria may be relative performance criteria. In some embodiments, the control server 122 may determine which potential hardware resource to select for providing the emulation by restarting the resource selection protocol.

In some embodiments, prior to returning an error message, control server 122 may check whether another emulator server 126 is capable of providing the kind of external hardware resource usable for providing the emulation. If another emulator server 126 is capable of providing the kind of external hardware resource as both an emulated and non-emulated hardware resource, then control server 122 may select which potential hardware resource to request from that emulator server 126 based on the resource selection protocol. If another emulator server 126 is capable of providing the kind of external hardware resource as either the emulated or non-emulated hardware resource, but not both, and that hardware resource satisfies the corresponding required state criteria, then control server 122 may select that potential hardware resource. If no other emulator server 126 is capable of providing the kind of external hardware resource, or if the potential hardware resources of a capable emulator server 126 fail to satisfy the required state criteria, then control server 122 may return an error message indicating that kind of external hardware resource usable for providing the emulation is unavailable at this time.

### Selecting Among a Plurality of Emulated and Non-Emulated Hardware Resources

In some embodiments, control server 122 may operate to select for each kind of external hardware resource, among a plurality of potential emulated hardware resources and a plurality of potential non-emulated hardware resources for providing that kind of external hardware resource for the emulation.

For example, as noted above, at step 330, control server 122 may identify more than one emulator server 126. In some embodiments, more than one of the identified emulator servers 126 may be capable of providing the kind of external hardware resource as both an emulated hardware resource and a non-emulated hardware resource. Further, in some embodiments, one identified emulator server 126 may be capable of providing the kind of external hardware resource only as an emulated hardware resource, whereas another identified emulator server 126 may be capable of providing the kind of external hardware resource only as a non-emulated hardware resource. In addition, in some embodiments, an identified emulator server 126 may include two or more non-emulated hardware resources, each capable of being provided as the kind of external hardware resource. For example, the kind of external hardware resource may be an ARM processor, and the identified emulator server 126 may include two physical ARM processors, each in communication with the main processor of emulator server 126 via a PCI bus.

In such scenarios, control server 122 may select among each of the potential emulated and non-emulated hardware resources for providing that kind of external hardware resource usable for providing the emulation based on the resource selection protocol. For example, control server 122 may determine the resource state of each potential emulated and non-emulated hardware resource based on the resource selection protocol. If the resource state of each hardware resource satisfies the required state criteria, then control server 122 may proceed to make a default selection if one is specified. If no default selection is specified, then control server 122 may proceed to determine and compare performance indicators of each potential hardware resource as outlined above. Control server 122 may then select among the plurality of potential emulated and non-emulated hardware resources for that kind of external hardware resource based on which potential hardware resource has the highest performance indicator.

In response to making a selection at step 350, control server 122 can link selection data with the session identifier and the corresponding hardware resource identifiers. For example, control server 122 can store the selection data in database 140 in association with the session identifier, the corresponding emulator server identifiers, and the hardware resource identifiers. The selection data may identify which kind of external hardware resources to provide as emulated hardware resources and which kind of external hardware resources to provide as non-emulated hardware resources. In some embodiments, the selection data may also identify which emulator servers 126 are to provide respective kinds of external hardware resources.

### Step 360

At step 360, control server 122 can initiate the emulation session by instructing the at least one identified emulator server 126 to provide the requested emulation to client device 110 using the selected resources selected at step 350.

In some embodiments, control server 122 may access database 140 to define session data for the emulation session based on the emulation session identifier. The information to be provided as part of the session data may already be linked to the relevant emulation session identifier or may not yet be linked. For example, defining session data for the emulation session may include linking stored data, such as emulation parameters and identifiers, for use in initiating, providing, and managing the emulation.

In some embodiments, the session data can include the resource identifiers for identifying the at least one kind of external hardware resource usable to provide the emulation, the selection data for identifying whether to provide a certain kind of external hardware resources as emulated or non-emulated hardware resources, emulator server identifiers for identifying which emulator server 126 is to provide a particular kind of external hardware resource, and the emulation data defining, for example, the computer product to be emulated and one or more properties of the emulation.

Once the session data is defined, control server 122 can proceed, based on the session data, to initiate the operation of the at least one identified emulator server 126 to provide the requested emulation. For example, the control server 122 may operate to send an initiation request to the at least one identified emulator server 126. The initiation request may include the emulation request and initiation parameters of the emulation corresponding to the emulation request. The initiation parameters of the emulation may include, for example, a list of at least one kind of external hardware resource usable for providing the emulation, as well as the selection data identifying whether to provide a certain kind of external hardware resource as an emulated or a non-emulated hardware resource.

In response to receiving the initiation request, emulator server 126 may proceed to initialize the selected resources for providing the emulation pursuant to the initiation parameters and the emulation request received from client device 110. For example, emulator server 126 may initialize the selected emulated and non-emulated hardware components and other resources usable for providing the emulation, such as operating system components and application components. If control server 122 determined that another emulator server 126 is to provide an operating instance of a kind of external hardware resource, then emulator server 126 or control server 122 may request the other emulator server 126 to initialize and make available the operating instance of that kind of external hardware resource to the identified emulator server 126. After the operating instances of the at least one kind of external hardware resources are initialized, the at least one identified emulator server 126 may operate to provide the emulation to client device 110.

In response to the emulation being provided to client device 110, control server 122 may designate the emulation session as an active emulation session.

### Step 370

In some embodiments, the process 300 terminate the emulation is initialized, as shown by dashed lines in FIG. 3. In other embodiments, the process 300 may continue to step 370. At step 370, control server 122 may operate to monitor and manage the active emulation session provided to the client device 110. In some embodiments, control server 122 may monitor, by periodically requesting operational data from the at least one identified emulator server 126 and any other emulator server 126 providing operating instances of the at least one kind of external hardware resource for providing the emulation. Based on the received operational data, control server 122 may determine whether to initiate a transition between the use of emulated and non-emulated hardware resources.

Control server 122 may determine whether to transition between emulated and non-emulated hardware resources based on transition criteria and operational considerations similar to those described at step 350.

Reference is now made to FIG. 4 for an example of transitioning between emulated and non-emulated hardware resources in some embodiments. At step 350, control server 122 may have initially selected to provide the emulation using an emulated hardware resource for a kind of external hardware resource. This selection may have been a result of determining that a corresponding non-emulated hardware resource for that kind of external hardware resource was unavailable at the time of selection. At step 370, control server 122 may monitor and manage the active emulation session provided to the client device 110 by the example process step 400. At step 410, the control server 122 may monitor the non-emulated resource state. If control server 122 determines based on the operational data that the non-emulated hardware resource for that kind of external hardware resource has since become available by detecting at step 420 that the non-emulated resource required state criteria is satisfied, then control server 122 may proceed to determine whether it would be beneficial to transition to providing the emulation using the non-emulated hardware resource for that kind of external hardware resource. In some embodiments, control server 122 may make such a determination by, for example, determining and comparing the dynamic performance indicator for the emulated and non-emulated hardware resources for that kind of external hardware resource. At step 430, control server 122 may then initiate a transition if performance of the emulation would improve as a result of transitioning from the initially selected emulated hardware resource to the non-emulated hardware resource for that kind of external hardware resource.

In some embodiments, control server 122 may select to initiate a transition for a kind of external hardware resource based on determining that the operating instance of the emulated or non-emulated hardware resource currently in use and provided by a first emulator server 126 is experiencing an operational error. For example, if a non-emulated hardware resource stops functioning, is physically dislodged from the first emulator server 126, or is operating above a designated temperature threshold, control server 122 may receive an indication that the non-emulated hardware resource is experiencing an operational error. In this case, control server 122 may determine a resource state of a non-emulated hardware resource providable by a second emulator server 126. If the resource state of the non-emulated hardware resource providable by the second emulator server 126 satisfies the state criteria, then control server 122 may instruct the first emulator server 126 to transition to the non-emulated hardware resource providable by the second emulator server 126 for the emulation session. If the resource state of the non-emulated hardware resource providable by the second emulator server 126 does not satisfy the state criteria, then control server 122 may determine the corresponding emulated hardware resource providable by the first emulator server 126. If the resource state of the emulated hardware resource satisfies the state criteria, then control server 122 may instruct the first emulator server 126 to transition to the emulated hardware resource providable by the first emulator server 126 for the emulation session.

Reference is now made to FIG. 5 for another example of transitioning between emulated and non-emulated hardware resource based on the relative performance criterion. At step 350, control server 122 may have initially selected to provide the emulation using an emulated hardware resource or a non-emulated hardware resource for a kind of external hardware resource. This selection may have been a result of determining that the relative performance criterion indicated greater emulated resource performance or greater non-emulated resource performance for that kind of external hardware resource was at the time of selection. At step 370, control server 122 may monitor and manage the active emulation session provided to the client device 110 by the example process 500.

At step 510, the control server 122 may monitor the non-emulated performance indicator and the emulated performance indicator for that kind of external hardware resource. At step 520, the control server may detect a change in the relative performance criterion to indicate a new relative performance criterion state.

At step 530, the control server 122 determines based on the new relative performance criterion state that the emulated hardware resource for that kind of external hardware resource indicates greater emulated resource performance, then control server 122 may proceed to transition to providing the emulation using the emulated hardware resource for that kind of external hardware resource. At step 540, the control server 122 determines based on the new relative performance criterion state that the non-emulated resource for that kind of external hardware resource indicates greater non-emulated resource performance, then control server 122 may proceed to transition to providing the emulation using the non-emulated hardware resource for that kind of external hardware resource.

Otherwise, the new relative performance criterion state is indicative substantially equal resource performance. If the new relative performance criterion state is indicative substantially equal resource performance, then at step 550, the control server 122 may determine if the operating instance provided by the emulated hardware resource or the non-emulated hardware resource initially selected should be maintained based on an additional selection criteria. If based on the additional selection criteria, it is determined that the operating instance provided by the emulated hardware resource initially selected should not be maintained, then the operating instance may be transitioned to the non-emulated hardware resource at step 560. Similarly, if based on the additional selection criteria, it is determined that the operating instance provided by the non-emulated hardware resource initially selected should not be maintained, then the operating instance may be transitioned to the emulated hardware resource at step 560. If based on the additional selection criteria, it is determined that the operating instance provided by the non-emulated hardware resource or the emulated hardware resource initially selected be maintained, then the operating instance may be maintained at step 570.

In some embodiments, control server 122 may select to initiate a transition between an emulated and non-emulated hardware resource for a kind of external hardware resource based on a high current or expected demand for the non-emulated hardware resource, or for the hardware components usable to provide the emulated hardware resource.

In some embodiments, control server 122 may select to transition between resources based on user data associated with emulation requests. For example, control server 122 may determine based on an emulation request and user data stored in database 140 that a user requesting an emulation is associated with a particular user priority. The user priority may be one of an ordered set of user priorities. In some embodiments, the ordered set of user priorities may include a high-priority and a low-priority. For example, a user requesting an emulation may be a high-priority user. In this case, control server 122 may instruct emulator server 126 to prioritize a high-performance non-emulated hardware resource for the emulation session of the high-priority user. If the high-performance non-emulated hardware resource is currently in use for providing an emulation session to a lower-priority user, control server 122 may initiate a transition for the emulation session of the lower-priority user from the high-performance non-emulated hardware resource to a lower-performance emulated hardware resource. In some embodiments, if a lower performance emulated hardware resource is not available, the emulation session of the lower-priority user may be terminated in order to prioritize a high-performance non-emulated hardware resource for the emulation session of the high-priority user.

It will be understood that the transition may be initiated between emulated and non-emulated hardware resources of the same emulator server 126, as well as between emulated and non-emulated hardware resources of different emulator servers 126.

It will be understood that different variations of processes 300, 400, and 500 may be provided.

The present invention has been described here by way of example only. Various modification and variations may be made to these exemplary embodiments without departing from the spirit and scope of the invention.

1. A method of providing an emulation of a computer product, the method comprising:
receiving an emulation request for the computer product from a client device;
determining from the emulation request and the client device a plurality of emulation parameters, including
the computer product to be emulated,
at least one kind of external resource usable to provide the emulation of the computer product, the at least one kind of external resource comprising at least one kind of external hardware resource usable to provide the emulation of the computer product, the at least one kind of external hardware resource not being providable by the client device and being providable as an emulated hardware resource and as a non-emulated hardware resource, and
selection criteria for determining whether to provide the at least one kind of external hardware resource as an emulated hardware resource or as a non-emulated hardware resource;
selecting selected resources for providing the emulation by, for each of the at least one kind of external hardware resource, selecting one and only one of the emulated hardware resource and the non-emulated hardware resource to provide an operating instance of the at least one kind of external hardware resource for the emulation based at least in part on the selection criteria; and
providing the emulation to the client device using the selected resources.

2. The method of claim 1 wherein for each of the at least one kind of external hardware resource:
the selection criteria comprise
i) an emulated resource required state criteria that is satisfied if and only if an emulated resource state of at least one potential emulated hardware resource of that kind of external hardware resource is available, the emulated resource state being one of available and unavailable; and
ii) a non-emulated resource required state criteria that is satisfied if and only if a non-emulated resource state of at least one potential non-emulated hardware resource of that kind of external hardware resource is available, the non-emulated resource state being one of available and unavailable;
the selecting selected resources comprises selecting the one and only one of the emulated hardware resource and the non-emulated hardware resource based at least in part on the emulated resource required state criteria and the non-emulated resource required state criteria, the emulated hardware resource being selectable only if the emulated resource required state criteria is satisfied, and the non-emulated hardware resource being selectable only if the non-emulated resource required state criteria is satisfied.

3. The method of claim 2 further comprising:
determining the emulated resource state by
determining an emulated resource operational characteristic defining usage of the at least one potential emulated resource of that kind of external hardware resource other than for the emulation; and
determining that the emulated resource state is available when the emulated resource operational characteristic is less than a first threshold usage for the at least one potential emulated hardware resource of that kind of external hardware resource, and otherwise determining that the emulated resource state is unavailable; and
determining the non-emulated resource state by
determining a non-emulated resource operational characteristic defining usage of the at least one potential non-emulated resource of that kind of external hardware resource other than for the emulation; and
determining that the non-emulated resource state is available when the non-emulated resource operational characteristic is less than a second threshold usage for the at least one potential non-emulated hardware resource of that kind of external hardware resource, and otherwise determining that the non-emulated resource state is unavailable.

4. The method of claim 2 wherein:
the selecting selected resources further comprises, for each of the at least one kind of external hardware resource,
if one and only one of the non-emulated resource required state criteria and the emulated resource required state criteria is satisfied, selecting the one of the non-emulated hardware resource and the emulated hardware resource corresponding to the one of the non-emulated resource required state criteria and the emulated resource required state criteria that is satisfied, and
if the non-emulated resource required state criteria and the emulated resource required state criteria are both satisfied, selecting the one of the non-emulated hardware resource and the emulated hardware resource based on at least one additional selection criterion of the selection criteria,
otherwise,
monitoring the emulated resource state and the non-emulated resource state until at least one of the emulated resource required state criteria and the non-emulated resource required state criteria is satisfied; and
upon detecting that at least one of the emulated resource required state criteria and the non-emulated resource required state criteria is satisfied,
if one and only one of the non-emulated resource required state criteria and the emulated resource required state criteria is satisfied, selecting the one of the non-emulated hardware resource and the emulated hardware resource corresponding to the one of the non-emulated resource required state criteria and the emulated resource required state criteria that is satisfied, and
otherwise, selecting the one of the non-emulated hardware resource and the emulated hardware resource based on at least one additional selection criterion of the selection criteria.

5. The method of claim 2, wherein for a particular kind of external hardware resource, an emulated hardware resource is initially selected to provide the operating instance for that particular kind of external hardware resource and the non-emulated resource required state criteria is initially not satisfied, the method further comprises, for that particular kind of external hardware resource:
monitoring the non-emulated resource state;
detecting that the non-emulated resource required state criteria is satisfied from the monitoring of the non-emulated resource state; and
upon detecting that the non-emulated resource required state criteria is satisfied, transitioning the operating instance for that particular kind of external hardware resource from being provided by the emulated hardware resource to being provided by the non-emulated hardware resource.

6. The method of claim 2 wherein for each of the at least one kind of external hardware resource,
the at least one potential emulated hardware resource is providable by a first at least one emulator server amongst a plurality of emulator servers, and the emulated resource state is determined based on at least one emulator server specific emulated resource state, each emulator server specific emulated resource state being one of available and unavailable and corresponding to a state of a potential emulated hardware resource instance providable by a first particular emulator server of the first at least one emulator server, the emulated resource state being available if and only if any one of the at least one emulator server specific emulated resource state is available; and
the at least one potential non-emulated hardware resource is providable by a second at least one emulator server amongst the plurality of emulator servers, and the non-emulated resource state is determined based on at least one emulator server specific non-emulated resource state, each emulator server specific non-emulated resource state being one of available and unavailable and corresponding to a state of a potential non-emulated hardware resource instance providable by a second particular emulator server of the second at least one emulator server, the non-emulated resource state being available if and only if any one of the at least one emulator server specific non-emulated resource state is available.

7. The method of claim 6, wherein the selecting the one and only one of the emulated hardware resource and the non-emulated hardware resource comprises:
identifying selectable resource instances by
identifying each of the potential emulated hardware resource instances corresponding to an emulator server specific emulated resource state that is available as a selectable potential emulated resource instances;
identifying each of the potential non-emulated hardware resource instances corresponding to an emulator server specific non-emulated resource state that is available as a selectable potential non-emulated resource instances; and
identifying the selectable potential emulated resource instances and the selectable potential non-emulated resource instances as the selectable resource instances;
selecting one of the selectable resource instances as a selected resource instance to provide the operating instance of that kind of external hardware resource; and
selecting the one and only one of the emulated hardware resource and the non-emulated hardware resource based on the selected resource instance.

8. The method of claim 4, wherein the at least one additional selection criterion includes a relative performance criterion, and for each kind of external hardware resource, if the non-emulated resource required state criteria and the emulated resource required state criteria are both satisfied, the method further comprises
assessing the relative performance criterion by
determining an emulated resource performance indicator defining performance of at least one potential emulated hardware resource of that kind of external hardware resource;
determining a non-emulated resource performance indicator defining performance of at least one potential non-emulated hardware resource of that kind of external hardware resource; and
assessing the relative performance criterion by comparing the emulated resource performance indicator and the non-emulated resource performance indicator, the relative performance criterion indicating one of greater emulated resource performance, greater non-emulated resource performance, and substantially equal resource performance; and
selecting the one of the non-emulated hardware resource and the emulated hardware resource based on the relative performance criterion.

9. The method of claim 8, wherein for a particular kind of external hardware resource, the relative performance criterion initially indicates one of greater emulated resource performance and greater non-emulated resource performance, and a particular one of the emulated hardware resource and the non-emulated hardware resource is initially selected corresponding to the one of the greater emulated resource performance and the greater non-emulated resource performance to provide the operating instance for that particular kind of external hardware resource, and the method further comprises for that particular kind of external hardware resource:
monitoring the non-emulated performance indicator and the emulated performance indicator;
detecting a change in the relative performance criterion to indicate a new relative performance criterion state from the monitoring of the non-emulated performance indicator and the emulated performance indicator; and
upon detecting the change in the relative performance criterion,
if the new relative performance criterion state indicates greater emulated resource performance, transitioning the operating instance of that kind of external hardware resource to the emulated hardware resource;
if the new relative performance criterion state indicates greater non-emulated resource performance, transitioning the operating instance of that kind of external hardware resource to the non-emulated hardware resource;
otherwise,
determining if the operating instance of that kind of external hardware resource should be maintained on the particular one of the emulated hardware resource and the non-emulated hardware resource initially selected based on another at least one additional selection criterion; and
if the operating instance of that kind of external hardware resource should not be maintained then transitioning the operating instance of that kind of external hardware resource to the other of the emulated hardware resource and the non-emulated hardware resource;
otherwise maintaining the operating instance on the particular one of the emulated hardware resource and the non-emulated hardware resource initially selected.

10. The method of claim 8 wherein:
the relative performance criterion comprises a static performance criterion, the static performance criterion being assessed by
determining an emulated resource static performance indicator defining an emulated static performance of at least one potential emulated hardware resource of that kind of external hardware resource, the emulated resource static performance indicator determined based at least in part on defined emulated performance specifications of the at least one potential emulated resource of that kind of external hardware resource;
determining a non-emulated resource static performance indicator defining a non-emulated static performance of at least one potential emulated hardware resource of that kind of external hardware resource, the non-emulated resource static performance indicator determined based at least in part on defined non-emulated performance specifications of the at least one potential non-emulated resource of that kind of external hardware resource; and
assessing the static performance criterion by comparing the emulated resource static performance indicator and the non-emulated resource static performance indicator; and
the selecting the one and only one of the emulated hardware resource and the non-emulated hardware resource is based on the static performance criterion.

11. The method of claim 10 wherein:
the static performance criterion
indicates greater emulated static resource performance if the emulated static performance indicator is greater than the non-emulated static performance indicator by an emulated static performance threshold;
indicates greater non-emulated static resource performance if the non-emulated resource static performance indicator is greater than the emulated static performance indicator by a non-emulated static performance threshold; and
otherwise indicates substantially equal static resource performance; and
the selecting the one and only one of the emulated hardware resource and the non-emulated hardware resource based on the static performance criterion comprises:
if the static performance criterion indicates the greater emulated static resource performance, then selecting the emulated hardware resource;
if the static performance criterion indicates the greater non-emulated static resource performance, then selecting the non-emulated hardware resource; and
if the static performance criterion indicates substantially equal static resource performance, then selecting the one and only one of the emulated hardware resource and the non-emulated hardware resource based on another at least one additional selection criterion.

12. The method of claim 8 wherein:
the relative performance criterion comprises a dynamic performance criterion, the dynamic performance criterion being assessed by
determining an emulated resource dynamic performance indicator defining an emulated dynamic performance of at least one potential emulated hardware resource of that kind of external hardware resource, the emulated resource dynamic performance indicator determined based at least in part on an emulated resource operational characteristic and performance specifications of the at least one potential emulated resource, the emulated resource operational characteristic defining usage of the at least one potential emulated resource of that kind of external hardware resource other than for the emulation and;
determining a non-emulated resource dynamic performance indicator defining a non-emulated dynamic performance of at least one potential emulated hardware resource of that kind of external hardware resource, the non-emulated resource dynamic performance indicator determined based at least in part on determining a non-emulated resource operational characteristic and performance specifications of the at least one potential non-emulated resource, the non-emulated resource operational characteristic defining usage of the at least one potential non-emulated resource of that kind of external hardware resource other than for the emulation; and
assessing the dynamic performance criterion by comparing the emulated resource dynamic performance indicator and the non-emulated resource dynamic performance indicator; and
the selecting the one and only one of the emulated hardware resource and the non-emulated hardware resource is based on the dynamic performance criterion.

13. The method of claim 12 wherein:
the dynamic performance criterion
indicates greater emulated dynamic resource performance if the emulated dynamic performance indicator is greater than the non-emulated dynamic performance indicator by an emulated dynamic performance threshold;
indicates greater non-emulated dynamic resource performance if the non-emulated resource dynamic performance indicator is greater than the emulated dynamic performance indicator by a non-emulated dynamic performance threshold; and
otherwise indicates substantially equal dynamic resource performance; and
the selecting the one and only one of the emulated hardware resource and the non-emulated hardware resource based on the dynamic performance criterion comprises:
if the dynamic performance criterion indicates the greater emulated dynamic resource performance, then selecting the emulated hardware resource;
if the dynamic performance criterion indicates the greater non-emulated dynamic resource performance, then selecting the non-emulated hardware resource; and
if the dynamic performance criterion indicates substantially equal dynamic resource performance, then selecting the one and only one of the emulated hardware resource and the non-emulated hardware resource based on another at least one additional selection criterion.

14. The method of claim 4 wherein the at least one additional selection criterion include a default selection of one of the non-emulated hardware resource and the emulated hardware resource.

15. The method of claim 2, wherein the plurality of emulation parameters further comprises a first user priority corresponding to a user of the client device, the first user priority being one of a plurality of ordered priorities, and the method further comprises:
determining that a particular one of the emulated resource required state criteria and the non-emulated resource required state criteria is not satisfied;
identifying usage of one of the at least one potential non-emulated hardware resource and the at least one potential emulated hardware resource to provide, at a second client device, a second operating instance of the at least one kind of external hardware resource for a second emulation at the second client device, the one of the at least one potential non-emulated hardware resource and the at least one potential emulated hardware resource corresponding to the particular one of the emulated resource required state criteria and the non-emulated resource required state criteria that is not satisfied;
determining a second user priority for a user of the second client device;
determining that the second user priority is lower in priority than the first user priority;
stopping provision of the second operating instance by the one of the at least one potential non-emulated hardware resource and the at least one potential emulated hardware resource; and
selecting the one of the at least one potential non-emulated hardware resource and the at least one potential emulated hardware resource to provide the operating instance of the at least one kind of external hardware resource for the emulation.

16. A system for providing an emulation of a computer product, the system comprising:
an emulation control server for communicating with a client device over a network, wherein the emulation control server is configured to:
receive an emulation request for the computer product from the client device;
determine from the emulation request and the client device a plurality of emulation parameters, including
the computer product to be emulated,
at least one kind of external resource usable to provide the emulation of the computer product, the at least one kind of external resource comprising at least one kind of external hardware resource usable to provide the emulation of the computer product, the at least one kind of external hardware resource not being providable by the client device and being providable as an emulated hardware resource and as a non-emulated hardware resource, and
selection criteria for determining whether to provide the at least one kind of external hardware resource as an emulated hardware resource or as a non-emulated hardware resource;
select selected resources for providing the emulation by, for each of the at least one kind of external hardware resource, selecting one and only one of the emulated hardware resource and the non-emulated hardware resource to provide an operating instance of the at least one kind of external hardware resource for the emulation based at least in part on the selection criteria; and
provide the emulation to the client device using the selected resources.

17. The system of claim 16 wherein for each of the at least one kind of external hardware resource:
the selection criteria comprise
i) an emulated resource required state criteria that is satisfied if and only if an emulated resource state of at least one potential emulated hardware resource of that kind of external hardware resource is available, the emulated resource state being one of available and unavailable; and
ii) a non-emulated resource required state criteria that is satisfied if and only if a non-emulated resource state of at least one potential non-emulated hardware resource of that kind of external hardware resource is available, the non-emulated resource state being one of available and unavailable;
the select selected resources comprises selecting the one and only one of the emulated hardware resource and the non-emulated hardware resource based at least in part on the emulated resource required state criteria and the non-emulated resource required state criteria, the emulated hardware resource being selectable only if the emulated resource required state criteria is satisfied, and the non-emulated hardware resource being selectable only if the non-emulated resource required state criteria is satisfied.

18. The system of claim 17 wherein the emulation control server is further configured to:
determine the emulated resource state by
determining an emulated resource operational characteristic defining usage of the at least one potential emulated resource of that kind of external hardware resource other than for the emulation; and
determining that the emulated resource state is available when the emulated resource operational characteristic is less than a first threshold usage for the at least one potential emulated hardware resource of that kind of external hardware resource, and otherwise determining that the emulated resource state is unavailable; and
determine the non-emulated resource state by
determining a non-emulated resource operational characteristic defining usage of the at least one potential non-emulated resource of that kind of external hardware resource other than for the emulation; and
determining that the non-emulated resource state is available when the non-emulated resource operational characteristic is less than a second threshold usage for the at least one potential non-emulated hardware resource of that kind of external hardware resource, and otherwise determining that the non-emulated resource state is unavailable.

19. The system of claim 17 wherein:
the select selected resources further comprises, for each of the at least one kind of external hardware resource,
if one and only one of the non-emulated resource required state criteria and the emulated resource required state criteria is satisfied, select the one of the non-emulated hardware resource and the emulated hardware resource corresponding to the one of the non-emulated resource required state criteria and the emulated resource required state criteria that is satisfied, and
if the non-emulated resource required state criteria and the emulated resource required state criteria are both satisfied, select the one of the non-emulated hardware resource and the emulated hardware resource based on at least one additional selection criterion of the selection criteria,
otherwise,
monitor the emulated resource state and the non-emulated resource state until at least one of the emulated resource required state criteria and the non-emulated resource required state criteria is satisfied; and
upon detecting that at least one of the emulated resource required state criteria and the non-emulated resource required state criteria is satisfied,
if one and only one of the non-emulated resource required state criteria and the emulated resource required state criteria is satisfied, select the one of the non-emulated hardware resource and the emulated hardware resource corresponding to the one of the non-emulated resource required state criteria and the emulated resource required state criteria that is satisfied, and
otherwise, select the one of the non-emulated hardware resource and the emulated hardware resource based on at least one additional selection criterion of the selection criteria.

20. The system of claim 17, wherein for a particular kind of external hardware resource, an emulated hardware resource is initially selected to provide the operating instance for that particular kind of external hardware resource and the non-emulated resource required state criteria is initially not satisfied, the emulation control server is further configured to, for that particular kind of external hardware resource:
monitor the non-emulated resource state;
detect that the non-emulated resource required state criteria is satisfied from the monitoring of the non-emulated resource state; and
upon detecting that the non-emulated resource required state criteria is satisfied, transition the operating instance for that particular kind of external hardware resource from being provided by the emulated hardware resource to being provided by the non-emulated hardware resource.

21. The system of claim 17 wherein:
the system further comprises a plurality of emulator servers, the plurality of emulator servers being coupled to the emulation control server; and
for each of the at least one kind of external hardware resource,
the at least one potential emulated hardware resource is providable by a first at least one emulator server amongst the plurality of emulator servers, and the emulated resource state is determined based on at least one emulator server specific emulated resource state, each emulator server specific emulated resource state being one of available and unavailable and corresponding to a state of a potential emulated hardware resource instance providable by a first particular emulator server of the first at least one emulator server, the emulated resource state being available if and only if any one of the at least one emulator server specific emulated resource state is available; and
the at least one potential non-emulated hardware resource is providable by a second at least one emulator server amongst the plurality of emulator servers, and the non-emulated resource state is determined based on at least one emulator server specific non-emulated resource state, each emulator server specific non-emulated resource state being one of available and unavailable and corresponding to a state of a potential non-emulated hardware resource instance providable by a second particular emulator server of the second at least one emulator server, the non-emulated resource state being available if and only if any one of the at least one emulator server specific non-emulated resource state is available.

22. The system of claim 21, wherein the selecting the one and only one of the emulated hardware resource and the non-emulated hardware resource comprises:
identifying selectable resource instances by
identifying each of the potential emulated hardware resource instances corresponding to an emulator server specific emulated resource state that is available as a selectable potential emulated resource instances;
identifying each of the potential non-emulated hardware resource instances corresponding to an emulator server specific non-emulated resource state that is available as a selectable potential non-emulated resource instances; and
identifying the selectable potential emulated resource instances and the selectable potential non-emulated resource instances as the selectable resource instances;
selecting one of the selectable resource instances as a selected resource instance to provide the operating instance of that kind of external hardware resource; and
selecting the one and only one of the emulated hardware resource and the non-emulated hardware resource based on the selected resource instance.

23. The system of claim 19, wherein the at least one additional selection criterion includes a relative performance criterion, and for each kind of external hardware resource, if the non-emulated resource required state criteria and the emulated resource required state criteria are both satisfied, the emulation control server is further configured to:
assess the relative performance criterion by
determining an emulated resource performance indicator defining performance of at least one potential emulated hardware resource of that kind of external hardware resource;
determining a non-emulated resource performance indicator defining performance of at least one potential non-emulated hardware resource of that kind of external hardware resource; and
assessing the relative performance criterion by comparing the emulated resource performance indicator and the non-emulated resource performance indicator, the relative performance criterion indicating one of greater emulated resource performance, greater non-emulated resource performance, and substantially equal resource performance; and
select the one of the non-emulated hardware resource and the emulated hardware resource based on the relative performance criterion.

24. The system of claim 23, wherein for a particular kind of external hardware resource, the relative performance criterion initially indicates one of greater emulated resource performance and greater non-emulated resource performance, and a particular one of the emulated hardware resource and the non-emulated hardware resource is initially selected corresponding to the one of the greater emulated resource performance and the greater non-emulated resource performance to provide the operating instance for that particular kind of external hardware resource, and the emulation control server is further configured to, for that particular kind of external hardware resource:
monitor the non-emulated performance indicator and the emulated performance indicator;
detect a change in the relative performance criterion to indicate a new relative performance criterion state from the monitoring of the non-emulated performance indicator and the emulated performance indicator; and
upon detecting the change in the relative performance criterion,
if the new relative performance criterion state indicates greater emulated resource performance, transition the operating instance of that kind of external hardware resource to the emulated hardware resource;
if the new relative performance criterion state indicates greater non-emulated resource performance, transition the operating instance of that kind of external hardware resource to the non-emulated hardware resource;
otherwise,
determine if the operating instance of that kind of external hardware resource should be maintained on the particular one of the emulated hardware resource and the non-emulated hardware resource initially selected based on another at least one additional selection criterion; and
if the operating instance of that kind of external hardware resource should not be maintained then transition the operating instance of that kind of external hardware resource to the other of the emulated hardware resource and the non-emulated hardware resource;
otherwise maintain the operating instance on the particular one of the emulated hardware resource and the non-emulated hardware resource initially selected.

25. The system of claim 23 wherein:
the relative performance criterion comprises a static performance criterion, the static performance criterion being assessed by
determining an emulated resource static performance indicator defining an emulated static performance of at least one potential emulated hardware resource of that kind of external hardware resource, the emulated resource static performance indicator determined based at least in part on defined emulated performance specifications of the at least one potential emulated resource of that kind of external hardware resource;
determining a non-emulated resource static performance indicator defining a non-emulated static performance of at least one potential emulated hardware resource of that kind of external hardware resource, the non-emulated resource static performance indicator determined based at least in part on defined non-emulated performance specifications of the at least one potential non-emulated resource of that kind of external hardware resource; and
assessing the static performance criterion by comparing the emulated resource static performance indicator and the non-emulated resource static performance indicator; and
the selecting the one and only one of the emulated hardware resource and the non-emulated hardware resource is based on the static performance criterion.

26. The system of claim 25 wherein:
the static performance criterion
indicates greater emulated static resource performance if the emulated static performance indicator is greater than the non-emulated static performance indicator by an emulated static performance threshold;
indicates greater non-emulated static resource performance if the non-emulated resource static performance indicator is greater than the emulated static performance indicator by a non-emulated static performance threshold; and
otherwise indicates substantially equal static resource performance; and
the selecting the one and only one of the emulated hardware resource and the non-emulated hardware resource based on the static performance criterion comprises:
if the static performance criterion indicates the greater emulated static resource performance, then selecting the emulated hardware resource;
if the static performance criterion indicates the greater non-emulated static resource performance, then selecting the non-emulated hardware resource; and
if the static performance criterion indicates substantially equal static resource performance, then selecting the one and only one of the emulated hardware resource and the non-emulated hardware resource based on another at least one additional selection criterion.

27. The system of claim 23 wherein:
the relative performance criterion comprises a dynamic performance criterion, the dynamic performance criterion being assessed by
determining an emulated resource dynamic performance indicator defining an emulated dynamic performance of at least one potential emulated hardware resource of that kind of external hardware resource, the emulated resource dynamic performance indicator determined based at least in part on an emulated resource operational characteristic and performance specifications of the at least one potential emulated resource, the emulated resource operational characteristic defining usage of the at least one potential emulated resource of that kind of external hardware resource other than for the emulation and;
determining a non-emulated resource dynamic performance indicator defining a non-emulated dynamic performance of at least one potential emulated hardware resource of that kind of external hardware resource, the non-emulated resource dynamic performance indicator determined based at least in part on determining a non-emulated resource operational characteristic and performance specifications of the at least one potential non-emulated resource, the non-emulated resource operational characteristic defining usage of the at least one potential non-emulated resource of that kind of external hardware resource other than for the emulation; and
assessing the dynamic performance criterion by comparing the emulated resource dynamic performance indicator and the non-emulated resource dynamic performance indicator; and
the selecting the one and only one of the emulated hardware resource and the non-emulated hardware resource is based on the dynamic performance criterion.

28. The system of claim 27 wherein:
the dynamic performance criterion
indicates greater emulated dynamic resource performance if the emulated dynamic performance indicator is greater than the non-emulated dynamic performance indicator by an emulated dynamic performance threshold;
indicates greater non-emulated dynamic resource performance if the non-emulated resource dynamic performance indicator is greater than the emulated dynamic performance indicator by a non-emulated dynamic performance threshold; and
otherwise indicates substantially equal dynamic resource performance; and
the selecting the one and only one of the emulated hardware resource and the non-emulated hardware resource based on the dynamic performance criterion comprises:
if the dynamic performance criterion indicates the greater emulated dynamic resource performance, then selecting the emulated hardware resource;
if the dynamic performance criterion indicates the greater non-emulated dynamic resource performance, then selecting the non-emulated hardware resource; and
if the dynamic performance criterion indicates substantially equal dynamic resource performance, then selecting the one and only one of the emulated hardware resource and the non-emulated hardware resource based on another at least one additional selection criterion.

29. The system of claim 19 wherein the at least one additional selection criterion include a default selection of one of the non-emulated hardware resource and the emulated hardware resource.

30. The system of claim 17, wherein the plurality of emulation parameters further comprises a first user priority corresponding to a user of the client device, the first user priority being one of a plurality of ordered priorities, and the emulation control server is further configured to:
determine that a particular one of the emulated resource required state criteria and the non-emulated resource required state criteria is not satisfied;
identify usage of one of the at least one potential non-emulated hardware resource and the at least one potential emulated hardware resource to provide, at a second client device, a second operating instance of the at least one kind of external hardware resource for a second emulation at the second client device, the one of the at least one potential non-emulated hardware resource and the at least one potential emulated hardware resource corresponding to the particular one of the emulated resource required state criteria and the non-emulated resource required state criteria that is not satisfied;
determine a second user priority for a user of the second client device;
determine that the second user priority is lower in priority than the first user priority;
stop provisioning of the second operating instance by the one of the at least one potential non-emulated hardware resource and the at least one potential emulated hardware resource; and
select the one of the at least one potential non-emulated hardware resource and the at least one potential emulated hardware resource to provide the operating instance of the at least one kind of external hardware resource for the emulation.

31. A non-transitory computer-readable storage medium upon which a plurality of instructions are stored, the instructions for performing a method of providing an emulation of a computer product, the method comprising:
receiving an emulation request for the computer product from a client device;
determining from the emulation request and the client device a plurality of emulation parameters, including
the computer product to be emulated,
at least one kind of external resource usable to provide the emulation of the computer product, the at least one kind of external resource comprising at least one kind of external hardware resource usable to provide the emulation of the computer product, the at least one kind of external hardware resource not being providable by the client device and being providable as an emulated hardware resource and as a non-emulated hardware resource, and
selection criteria for determining whether to provide the at least one kind of external hardware resource as an emulated hardware resource or as a non-emulated hardware resource;
selecting selected resources for providing the emulation by, for each of the at least one kind of external hardware resource, selecting one and only one of the emulated hardware resource and the non-emulated hardware resource to provide an operating instance of the at least one kind of external hardware resource for the emulation based at least in part on the selection criteria; and
providing the emulation to the client device using the selected resources.
